(19) United States
(12) Patent Application Publication
(10) Pub. No.: US 2013/0333266 A1
(43) Pub. Date: Dec. 19, 2013

(54) Augmented Sight and Sensing System

(71) Applicants: Bradley H. Gose, Bryan, TX (US); Larry R. Echols, Canton, TX (US); Robert E. White, Bryan, TX (US); J. Michael Chambers, Stafford, TX (US)

(72) Inventors: Bradley H. Gose, Bryan, TX (US); Larry R. Echols, Canton, TX (US); Robert E. White, Bryan, TX (US); J. Michael Chambers, Stafford, TX (US)

(21) Appl. No.: 13/915,772

(22) Filed: Jun. 12, 2013

Related U.S. Application Data
(60) Provisional application No. 61/660,720, filed on Jun. 16, 2012.

(51) Int. Cl. F41G 1/00; G01J 1/04

(52) U.S. Cl. CPC F41G 1/00; G01J 1/0411
USPC 42/111; 348/340

(57) ABSTRACT

An augmented sight and sensing system that allows both improved pointing accuracy and improved detail of sensing information through a plurality of means that superimposes situation-relevant information on a target image in a manner that allows a composite image, with or without additional sensed information, to be detected at one or more subsequent sensory locations or devices. The system includes beam-splitting means to divide incoming light beams from a target image into two separate beams, one beam that may be collected by a first sensor (such as seen by an observer's eye or alternate sensor such as a camera) and the other collected by a second imaging sensor or module, and means to generate and superimpose information (such as a reticle) on the target image seen by both, and means to collect and transmit the composite image and information.

### CROSS-REFERENCE TO RELATED APPLICATION

This application claims the benefit and priority from U.S. Provisional Patent Application 61/660,720, filed Jun. 16, 2012, the contents and disclosure of which is incorporated herein by reference for all purposes.

### BACKGROUND

1. Field of the Invention

This invention relates to an augmented sight and sensing system. More specifically it is a system that allows improved pointing accuracy and improved detail of sensing information through a plurality of means that incorporates the superimposition of a “reticle” image upon the device's concurrent sensing of a target image in a manner that allows a composite image, with or without additional sensed information, to be detected at one or more subsequent sensory locations or devices.

2. Background

Aids to sighting systems have taken many forms to serve a variety of purposes and to incorporate new or improved materials or methods. Examples of sight systems include sights on weapons, on cameras, and other devices that require user-pointing control for correct operation. Examples of variants among those systems include iron sights, reflex sights, and holographic sights on weapons or other devices. Currently available reflex sighting systems generally cannot be easily expanded in functionality. In addition to reflex sights, electronic sighting systems that employ technology aided reticles typically utilize a small display screen directly in front of the eye and a camera module mounted at the front of the optics; on these systems the camera records all optical data and transmits it to the display, with the potential of added overlays such as an electronically generated reticle; these systems may also have limited image resolution. Such systems are subject to a variety of problems, including potential incompatibilities with lens systems, interference with secondary systems during power outages, unexpected power outages at critical moments, system failure due to moisture intrusion, increased eyestrain during low-light use and possibly even the illegality of use with a firearm.

Some disclosed sighting systems include, for example, US Reg. No. H1,891 that describes an apparatus for displaying and recording an image viewed by a marksman or shooter through a weapon sight having a beam-splitter and video camera.

U.S. patent application 2009/0168057 describes a reflex sight with a cross-hair reticle image that allows the user to view a target image and a superimposed reticle that is said to be not easily perceived by the target.

U.S. patent application 2010/00251593 describes a system to automatically calibrate a firearm using a reflex sight (beam-splitter) that projects a target image to a video camera with a computer processing element that assists in adjusting and calibrating the sight.

U.S. Patent application 2010//0258000, published Oct. 14, 2010 discloses a wireless, waterproof, remotely operated weapon-mounted sighting system having a camera, an operator borne CPU, and a “heads-up”/Mounted Display. This patent discloses a system with a digital reticle electronically superimposed (and electronically boresighted to the weapon) on an image from a weapon-mounted camera. The image is transferred via wire or wirelessly to a “heads-up” display. The software-generated reticle has no relationship to any other sighting device or system attached to, or integral with, the weapon. It is apparently a part of a family of sighting systems designated as “SmartSights”. The “SmartSights” have a camera mounted to the rail of a rifle that transmits live video to a small computer worn on the user's vest. This is claimed to be a significant improvement over a cancelled Army “Land Warrior” system that has proven to be too heavy for military use.

Most current sight or visioning systems, as those described above, are specifically designed as weapon sights, yet sighting and sensing systems have many potential uses beyond weapon sights, including use in any situation where accurate pointing and/or sighting is desirable, as, for example, where it is desirable to remotely view and optionally record a target image and associated audio. Accurate sighting may be coupled with appropriate means to manipulate various functions at or on the target.

It would be desirable to have a sighting and sensing system that provides a reticle type image or other situation-relevant data superimposed on a target image that could be concurrently viewable by a user (or image capture device) and captured by a second imaging sensor that would allow transmittal, viewing and/or recording of the same image that is observable by an on-sight or remote observer. The present invention provides such a system.

### SUMMARY

The present invention broadest scope is a sighting and sensing system comprising the components;

a.) a beamsplitter that separates a target image into at least two images, one for each of at least two image sensors;

b.) means for producing situation-relevant information;

c.) at least two image sensors;

d.) at least one imaging optic to focus at least one separated images at infinity for said sensors;

arranged in relationship to each other enabling each image sensor to simultaneously sense a target image or to sense a target image having superimposed upon it situation-relevant data images to form a composite image.
The system may also comprise at least one microphone to record the audio signals which correspond to received video signals.
This system overcomes many of the limitations of prior systems and expands the functionality of reflex style sights. It can provide a superior and lower cost reticle image; can include integrated night vision, thermographic imaging systems, X-ray or terahertz-wave body scanning systems, or other information sensed by the system. It is a sight and sensing system that augments the user's view by superimposition of a reticle images and other sighting aids. The system is, in one of its many applications, optionally mountable on a standardized mounting rail and may incorporate a wireless transceiver means capable of streaming live audio/video data to a device capable of receiving and displaying such data. It may also stream digital data containing measurements of sensed information and optionally incorporates functionality for recording live audio/video and still images for retrieval/playback from a storage device.

Moreover, the system allows a point-from-safety provision, natural target acquisition with aided or unaided eye, night/low-light target acquisition, aggregation and transmission of sensed data and video recording of the target images.

### DESCRIPTION OF THE DRAWINGS

FIG. 1 is a diagrammatic representation of one embodiment of the invention.

FIG. 2 is a diagrammatic representation of another embodiment of the invention.

FIG. 3 is an illustration of some possible reticle images of the invention.

FIG. 4 is a functional block diagram of some electronic aspects of the invention.

FIG. 5 is a diagrammatic representation of another embodiment of the invention.

FIG. 6 is a diagrammatic representation of some imaging aspects of the invention.

FIG. 7 is a diagrammatic representation of some preferred embodiments of the invention.

FIG. 8 is a functional block diagram of some preferred electronic aspects of the invention.

FIG. 9 is a diagrammatic representation of some imaging aspects of the invention.

FIG. 10 is a diagrammatic representation of one embodiment of the invention.

FIG. 11 is a diagrammatic representation of one embodiment of the invention.

### DETAILED DESCRIPTION

The present invention may be understood more readily by reference to the following detailed description of embodiments and the figures and examples. It is to be understood that this invention is not limited to specific systems or to particular embodiments, as such may, of course, vary.

In this specification and in the claims which follow, reference will be made to a number of terms which shall be defined to have the following meanings;

The singular forms “a”, “an” and “the” include plural referents unless the context clearly dictates otherwise.

“Optional” or “optionally” means that the subsequently described event or circumstances may or may not occur, and that the description includes instances where the event occurs and instances where it does not.

“Include” or “included” or “including” when used in reference to systems of the invention means that the subsequently named items or events may be a subset of a larger group of relevant items or events, and that the listing of items or events should not be construed to exclude items or events that are not named within that listing.

“Beamsplitter,” when used in reference to systems of the invention, means any of a variety of devices and materials or plurality of them that can divide an incoming light ray (beam) into two or more beams that are substantially identical. Beamsplitters may include, for example, cube beam splitters, Wollaston prisms, pellicle mirrors, dichroic mirrors or simply a flat pane of glass or plastic.

“Collimated light,” when used in reference to systems of the invention, means light whose rays are parallel and considered to be focused at infinity, and therefore will spread slowly as they propagate.

“Imaging optic,” when used in reference to systems of the invention, means a lens used to form an image consisting of a curved mirror or lens with some type of light source and/or an image at its focus. This can be used to replicate a target at infinity without parallax. Imaging optics can be, but not limited to, double convex lenses, plano-convex lenses, positive meniscus lenses, or off-axis parabolic mirrors.

“Engineered diffuser lens assembly,” when used in reference to systems of the invention, means any beam shaper capable of homogenizing light, shaping its intensity profile and distribution in space; thereby creating a new point source that is then collimated by an imaging optic.

“OAP,” when used in reference to systems of the invention, means off-axis paraboloidal mirror.

“Reticle,” when used in reference to systems of the invention, means an illuminated dot or shape produced by non-magnifying optical devices of various constructions (often called reflex sights, collimated reticles, or holographic reticles) that give the viewer an image of the aiming point superimposed over the field of view.

“Image sensor module,” when used in reference to systems of the invention, means a subassembly comprised of imaging optics and one or a plurality of digital image sensors (which may or may not be programmable) and supportive packaging and circuitry.

“Image sensor,” when used in reference to systems of the invention, means any type of digital image sensor without associated imaging optics; it may refer to one or a plurality of devices, which may or may not be programmable, and which are capable of receiving optical signals and converting them to electronic and/or digital signals in a defined pattern. An image sensor can also mean an observer's eye.

“Composite image,” when used in reference to systems of the invention, means the compound image formed by the superimposition of an image containing situation-relevant information, such as

a. a reticle image

b. device state information pictograms, such as battery charge indicators, wireless signal strength, on/off/standby status, current mode of operation, charging status, software update status, and any other displayable information regarding the state of the device itself;

c. situational awareness pictograms, such as 2D and 3D compasses, rally point markers, numerals for range to target and compass headings, virtual “sighting wires”, multiple target indicators, detected threat indicators, and any other displayable data that would inform the user of any information pertinent to his environment;

d. sensed information outside the visible spectrum such as light in the ultraviolet, near infrared, mid-infrared, far-infrared, or any wavelength that can be refracted or reflected with imaging optics or beamsplitters, onto a second image, such as a target image, such that combined image may seen by an observer or detected by a sensor.

“Processor,” when used in reference to systems of the invention, means one or a plurality of programmable devices that control and manage system functions, and which collect and manipulate data from other devices, which themselves may or may not be programmable.

“PCA,” when used in reference to systems of the invention, means printed circuit assembly, which is a printed circuit board (or a substrate providing similar function) that facilitates the use of electronics designs.

“Micro-display,” when used in reference to systems of the invention, means any substantially small electronic image generating apparatus such as those that are made from a variety of types of light emitting diodes or other display technologies that may be used to display an electronic image.

“Receiver,” when used in reference to systems of the invention, means a programmable or non-programmable device or plurality of devices that can receive analog or digital data, control signals, or one or more of these.

“Transmitter,” when used in reference to systems of the invention, means a programmable or non-programmable device or plurality of devices that can transmit analog or digital data, control signals, or one or more of these.

“Transceiver,” when used in reference to systems of the invention, means a programmable or non-programmable device or plurality of devices that can transmit and receive analog or digital data, or control signals, or one or more of these.

“Wireless receiver,” when used in reference to systems of the invention, means a receiver that does not require a physical connection to a transmitter.

“Wireless transmitter,” when used in reference to systems of the invention, means a transmitter that does not require a physical connection to a receiver.

“Communication,” when used in reference to systems of the invention, means the device or devices used to allow unidirectional, bidirectional or multidirectional exchange of information, or the act of using those devices.

“Standardized mount/ing rail,” when used in reference to systems of the invention, means a mounting rail of a standardized design that allows the installation and interchangeability of accessories from different sources and of different designs. These mounting rails are used on telescopes, firearms, optics, etc. and provide a standard interface to mount reflex sights, telescopic sights, lights, lasers, or any desirable accessory to various objects. Some such standard rails include the Weaver standard, Picatinny rail (also known as a MIL-STD-1913 rail), NATO accessory rail, dovetail mount, optical rail, or optical bench.

“audio/video” when used in reference to systems of the invention, means the associated acoustic signals that accompany a live event and are recorded and or transmitted. These audio signals are incorporated into the data stream using standard encoding techniques.

The present invention in broadest scope is a sighting and sensing system comprising:

1) a beamsplitting means to divide incoming light beams from a source (target) image into two or more separate beams, one of which beams may be collected by a primary sensor (such as seen by an observer's eye or alternate sensor such as an image sensor module) and one of which beams is collected by one or a plurality of secondary image sensors or image sensor modules;
2) a situation-relevant image generating means by which a light source projected out at infinity is directed into a beamsplitting means and then separated into two substantially identical beams that may enter the observer's eye (or a primary sensor) and a second image sensor or module substantially simultaneously. The situation-relevant image impinging on the second sensor is the actual image of the reticle itself, not an electronically generated digital image added during post processing of the target image;
3) a means to generate and superimpose an image (such as a reticle, augmented reality information, or more broadly “situation-relevant” information) onto a target image such that a composite image is created;
4) a means of image collection and manipulation such that the images collected by a second imaging sensor or module will be substantially identical to the images perceivable by the first sensor; and optionally,
5) a means to record or transmit the composite image and optional associated audio in any of a plurality of ways such as:

a) storage of the image within the system, in a fashion such that it may retrieved for further use within the system or external to the system

b) transmission of the image or audio/video to any of a wide variety locations or devices, using any of a wide variety of transmission or communication methods and associated devices, where the image maybe recorded, viewed, heard, processed, or otherwise acted upon.

The system components are, in one embodiment, preferably housed in a form that is mountable on a standardized mounting rail. While the sighting system is generally described herein as a weapons sight it is also useful for other sighting purposes such as surveillance, remote sensing, supervisory control and data acquisition (SCADA) and the like.

There are a myriad of uses that embodiments of the invention may be adapted to serve. For example, the system of the invention can also be implemented as a next generation security system that enables manual or automatic isolation of a threat from background movement and provide information for remotely acting upon this detection.

The information that may be obtained with the system can provide information simultaneously to a proximal user as well as to other people and devices. This enables capabilities for the system to be deployed for sighting in which the goal is not (immediately) to fire a weapon, but to identify an object or location of interest and transmit visual, audible, and additional cybernetic data (including positioning, target analysis and other types) to peer devices or to a central system. So for example, it is possible to pinpoint an object of interest and send an electronic message to a central recording system or a team decision maker that can also send back information on action to take toward that object or location as well as to other assets that may be under its control.

In non-combative use cases, the system may be used in sighting and sensing information for industrial use in which the augmentation allows a user to point at a distant object or location from which additional sensors can gather and concurrently transmit with the audio and/or visual data a variety of details about the object/location. For example, from a helicopter moving down a pipeline, the system could allow precise pointing to objects and locations on the pipeline that trigger collection of infrared data that could determine the location of a leak, or even a potential for a leak to occur. In SCADA (Supervisory Control and Data Acquisition) applications this capability can improve the accuracy of data gathered while reducing risk. The capabilities of the system also have applicability in tactical law enforcement and in a myriad of military uses for the automation of augmented intelligence gathering.

An important aspect of the invention is that it may be small in size and lightweight. A prototype of the complete system may be contained in a package size of about 5″×2″×2.5″. While not required for suitable operation of the system of this invention it is preferred that essential components be completely self-contained, designed to be resistant to dust damage, shock damage, moisture contamination, and to this end the system would be a completely sealed design-protected from such environmental damage. A sealed design requires the electronic system's power source to be charged remotely by means of wireless methods. Wireless charging can include, but isn't limited to inductive charging systems that remove the requirement for charging portholes and/or removable battery covers and seams.

Another important aspect of the invention is a point-from-safety provision providing the user the ability to accurately target from cover or protection using composite images and augmented information. In this point-from-safety provision the video display optionally displays an image of the target with an aiming spot superimposed thereon. The video display may be located remotely from the optical sight at some distance (such as a Smartphone or HUD), thus the user may optionally view the video display to effect aiming of the firearm or other device remotely or may place his eye or sensor in line with the aiming reticle and sight along it to effect aiming of the firearm or other device directly. Further, if used on a weapons platform as a primary aiming device, the user is assured of accurate target acquisition in a point-from-safety situation, irrespective of whether his eye or video display is used to affect aiming, because the reticle image is

a. the same image,

b. has an inseparable relationship to itself (unlike the “SmartSight” which has no relationship to the primary aiming device/s),

c. housed in a single device,

d. boresighted to the weapon.

The video display may display the aiming spot and an image of the target using software written specifically for the display to affect any number of novel aiming functions.

Aspects of embodiments of the invention are illustrated in the figures. Each of the embodiments will employ a hardware system that may be one of two types, a “basic” hardware system or an “advanced” hardware system, and each embodiment designates the type of hardware system used for that embodiment.

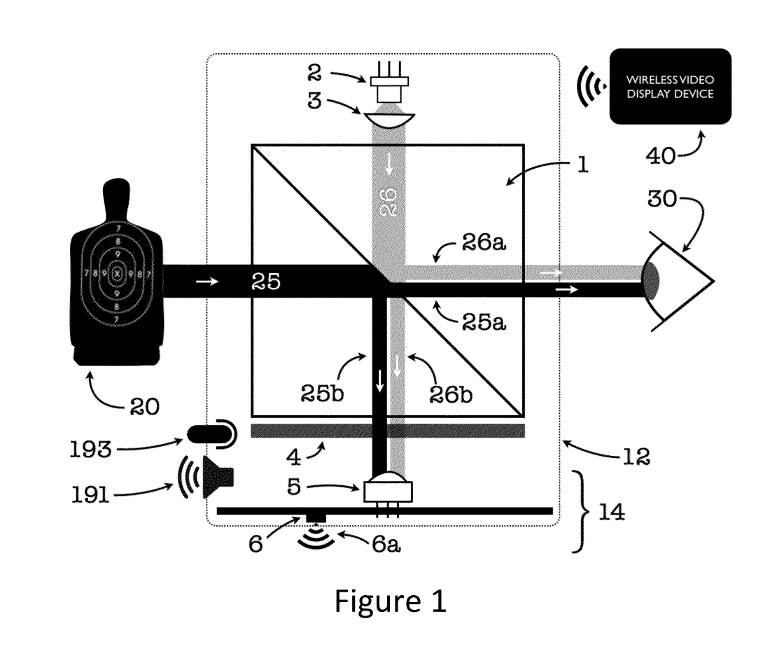

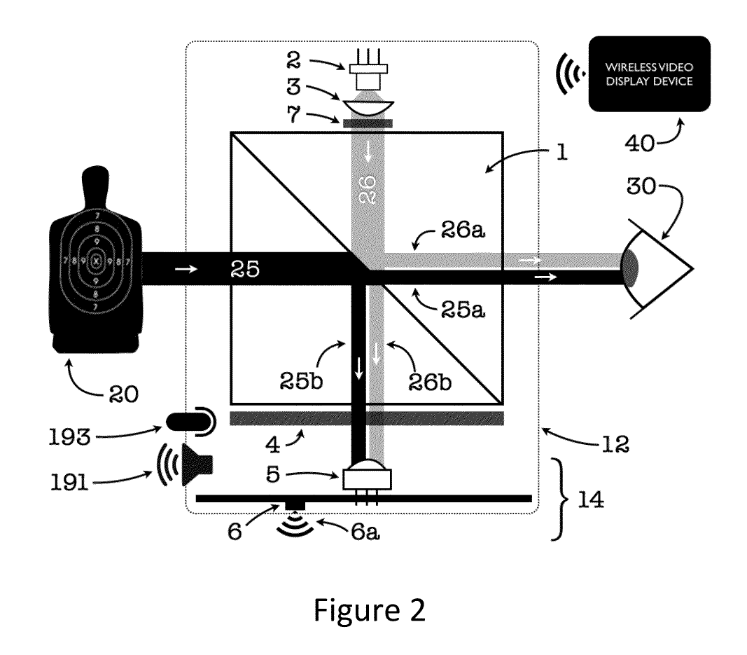

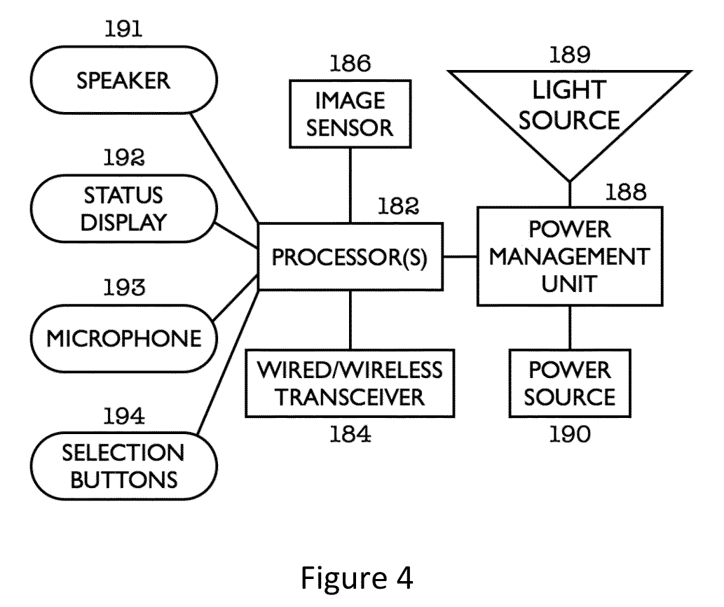

A suitable electronics system for the embodiments described as using the “basic” electronics system is illustrated in the functional block diagram in FIG. 4. The “basic” electronics system may reside on a PCA (14 in FIGS. 1 & 2) and may comprise a processor(s) (182), image sensor(s) (186) contained inside image sensor module(s) (5, FIGS. 1 and 2), power source (190), power management unit (188), and a light source (189). Items (194) are selection buttons to operate the functions of the system, and (192) are a status display of those systems or selections, item (191) is a speaker providing audible feedback of those selections and/or alternately used as a means to supplement augmented reality information. An important feature of the electronics system is the broadcast of audio captured with microphone (193) and/or video images through wired or wireless communication to a remote device, or many remote devices (see 6, 6a, and 14 of FIGS. 1 & 2, which illustrate a wireless communication configuration), where (14) is a PCA board, (6) is a wireless transceiver, and (6a) is a wireless signal. The wired or wireless communications transceiver (184) configuration may be managed using the selection buttons (194) and status display (192), including configuration for communications using either the wired or wireless transceivers (184) and may be used to select a communications mode that determines whether the system communication functions employed by the transceivers (184) will operate under the access control of a centralized device, communicate directly with peer devices, or both. In the primary operation mode (selected via control selection buttons (194)), the system broadcasts live video images of the target image (20) and reticle image (26) detected by the image sensor module (5).

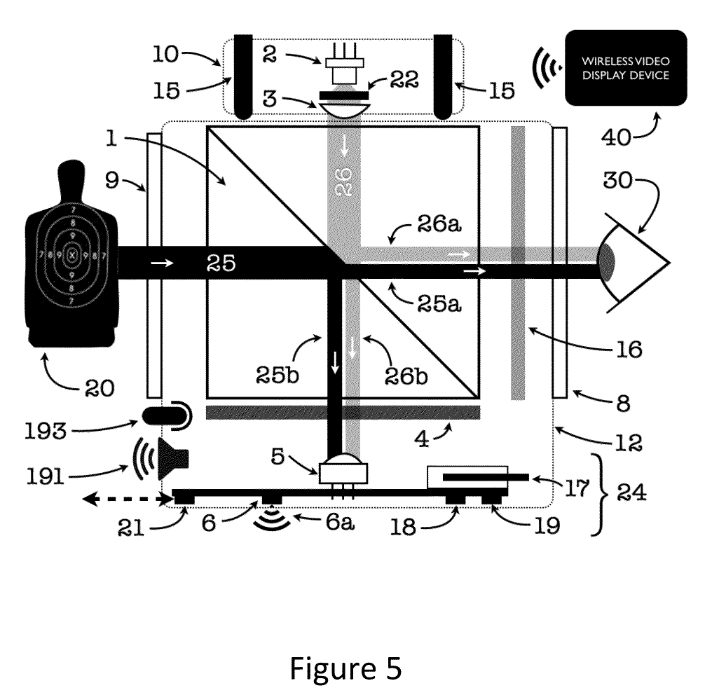

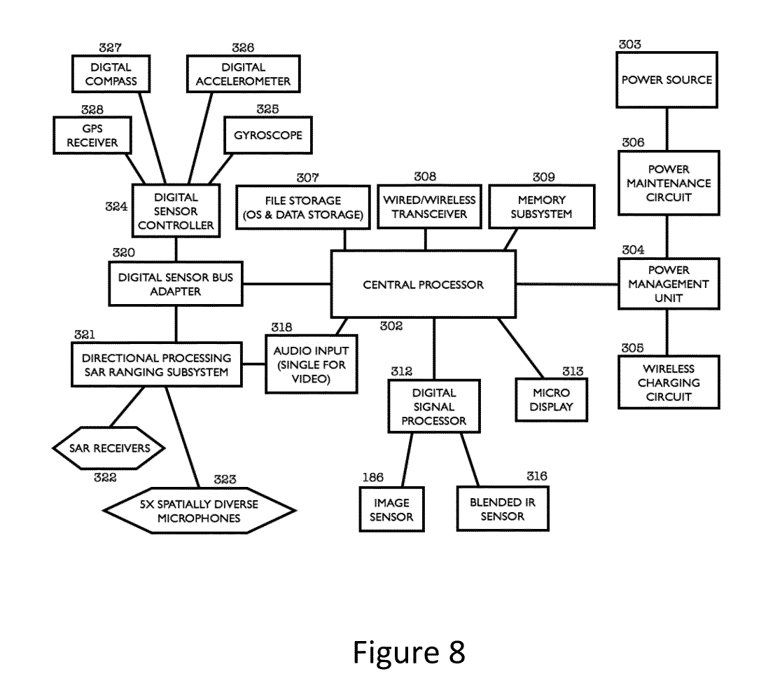

FIG. 8 is a functional block diagram showing the functions of the “advanced” electronics system, which comprises an integrated component board (PCA) (24, FIGS. 5 & 7), comprised of processor(s) (302), image sensors (186, 316), micro-display (313), digital signal processor (312), digital and analog sensor inputs (322, 323, 324, 325, 326, 327, 328), on-board file storage (307) and communications subsystem (308). The system's processor(s) (302) manages the system's electronic functions. A variety of the functions controlled and managed by the processor(s) include: a video processing and encoding subsystem (312) comprised of separate imaging subsystems (186, 316), GPIO interconnection(s) (320, 321), a memory subsystem (309), a storage subsystem(s) (307), interfaces for the communications subsystem(s) (308) and system support for (321, 322, 323). The electronics system and software system control the integration of a digital gyroscope (325), digital accelerometer (326), digital compass (327), and GPS receiver (328) data to accurately determine the system's physical geospatial location and orientation at all times during system use. The communications subsystem (308) supports wired and/or wireless communications (see 6, 6a, and 24 of FIGS. 5 & 7), which illustrate a wireless communication configuration, where (24) is a PCA board, (6) is a wireless transceiver, and (6a) is a wireless signal). In an important embodiment in which the sighting system is encased in a sealed housing, the electronics also comprise wireless charging means (305) and its supporting components (304, 306) of an on-board power source (303), allowing the entire system to be impact resistant and protected from environmental contaminants.

Both the “basic” and “advanced” electronics systems employ an integrated software system that coordinates, manages and controls the operation of the system according to the user supplied configuration settings, and where applicable the presence of optional or auxiliary devices, and it coordinates the operation of timing-sensitive functions of the system such as: digital signal processing (312), the micro-display subsystem (313), image sensors (186, 316), digital and analog sensor inputs (193, 322, 323, 325, 326, 327, 328), on-board file storage (307) and communications subsystem (308), and any ancillary processes that may be advantageous in certain applications of an embodiment. In some embodiments, the software system may also beneficially manipulate, alter, or correct information prior to its display (313) to the user, or further augment the information displayed (313), stored (307) and/or transmission by the communication system (308). The system software and hardware architecture support optional subsystems and features (described in each embodiment) when they are present, features and platform configuration changes, such as alternative wired or wireless communication methods, and/or updates to system software or firmware.

The software system may have several modes of operation, including: a) a live-video (with or without associated audio) streaming mode to one or more devices via the communications subsystem (308); b) a file access mode to allow access to stored files and images (307); c) a calibration mode allowing concurrent access to all sensors, data, and calibration of the display, and secondary subsystems; and d) a setup mode to allow for configuration and system maintenance. Under system software control, the communications subsystem (308) may be configured to provide remote access to various features of the system's modes of operation. Referencing FIG. 4 the wired or wireless communications transceiver(s) (184) configuration may be managed using the selection buttons (194) and status display (192), including configuration for communications using either the wired or wireless transceivers (184) and may be used to select a communications mode that determines whether the system communication functions employed by the transceivers (184) will operate under the access control of a centralized device, communicate directly with peer devices, or both. In the primary operation mode (selected via control selection buttons (194)), the system broadcasts live video images of the target image (20, see FIGS. 1, 2, 5, & 7) and reticle image (26) detected by an image sensor (5, 186).

The software may be used to enable a variety of conflict support capabilities including: data encryption, intelligence mode imaging, geospatial location of casualty, real-time electronic order of battle, silent distress or alert beacon, tactical mode geospatial target location communication for fire support, concurrent audio/video and data communications with or without encryption, in ITAR mode NSA and DoD approved vendor-blind encryption, captured weapon tracking and targeting beacon, tactical peer-to-peer coordinated attack, remotely engaged secure data self destruction, telemetry based device authentication with access rejection and reporting, and other uses, integration with C⁴I, LVC, NCW, and other programs and systems.

In an embodiment (FIG. 1) incorporating the “basic” electronics system (FIG. 4), there is a housing (12) (optionally mountable to a standard mounting rail), a beamsplitter (1) that separates a target image light beam (25) into beams (25a) and (25b). Beam (25a) may be seen by an observer or sensor (30) and (25b) by an imaging sensor module (5) after, optionally, passing through a band-pass wavelength filter (4) if the system incorporates imaging sensors used in light detection outside the range of the visible spectrum. The signal impinging on image sensor module (5) through wavelength filter (4) would be tailored for operation with the imaging sensor's wavelength sensitivity and by its nature allows operation of the reflex sight in low-light/no-light situations depending upon sensor composition such as short wave infrared, long wave infrared, terahertz, hinted short wave infrared, or other sensor devices suitable for threat or target detection, night vision, or other sensed data augmentation.

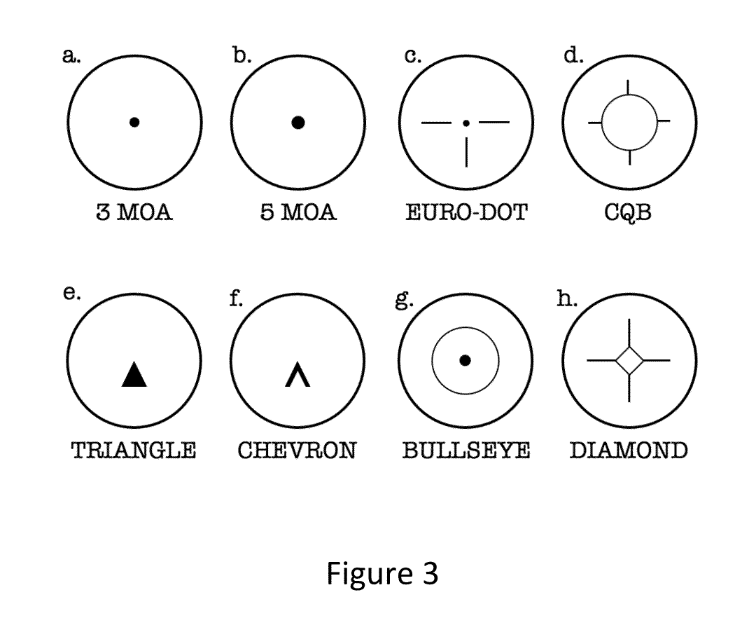

Reticle beam (26) produced by light source (2) and imaging optic (3) impinges on beam splitter (1) and is divided into beams (26b) where it may be detected by image sensor module (5) after, optionally, passing through a band-pass wavelength filter (4) (for the same reasons stated above), and (26a) to an observer or sensor (30) where the user may affect aiming of the device. Examples of possible reticle images are illustrated in FIGS. 3a and 3b, which are illustrative only and not limiting of the reticle spot diameters that may be generated.

The composite image from beams (25b) and (26b) (and any other sensed information) may be transmitted by means of wireless signal (6) to a suitable receiver (40) after processing by the PCA (14). The composite image produced from the target (20) and the reticle image (26) is simultaneously “seen” by observer or sensor (30) and image sensor module (5), and may be viewed in real-time via wireless video display device (40). The video data receiver and display device may be any suitable device known to those skilled in the art. In a preferred implementation it will be a heads up device (HUD).

In another basic embodiment (FIG. 2) incorporating the “basic” electronics system (FIG. 4), there is added an engineered diffuser lens assembly (7) that allows a shaped reticle to be viewed and projected. Examples of possible reticle images are illustrated in FIGS. 3c, 3d, 3e, 3f, 3g, and 3h, which are illustrative only and not limiting of the possibilities since any desired reticle image may be generated.

FIG. 5 illustrates an advanced embodiment of the invention, based on the “advanced” electronics system, showing many of the components that may be incorporated into the system within the broad basic scope and concept of the invention. Illustrated is a reflex sight functioning in the same manner as those in FIGS. 1 and 2, but the housing (12) (optionally mountable to a standard mounting rail) is fitted with a proximal aperture (8) and a distal aperture (9) that protect the beamsplitter (1) and transparent display (16) from environmental damage. Additionally, the sensed composite beam (25b+26b) may be stored on-board on a storage device (17) and/or transmitted to a wireless video display device (40).

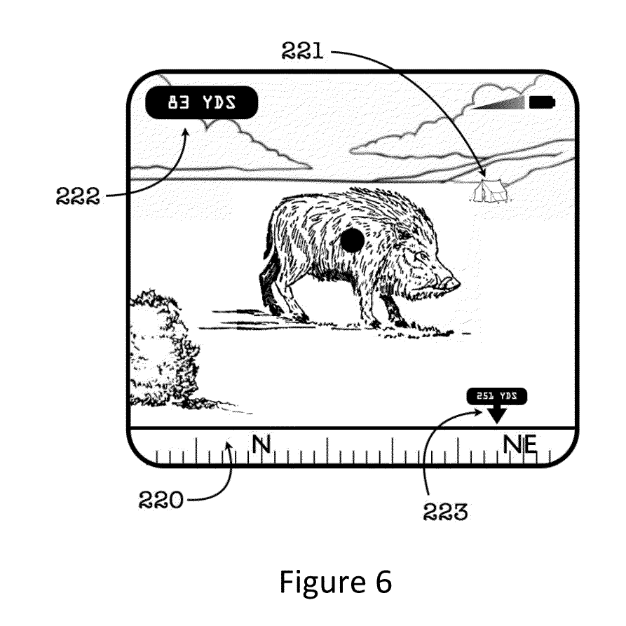

The simultaneous impingement of the targeting reticle image (26) generated by the imaging optical assembly (10) and the target image (25) entering through distal aperture (9) advantageously precludes the need for a software generated reticle on the wireless video display device (40) since the actual aiming reticle (as bore-sighted to a device via adjustment screws (15) co-located with the imaging optical assembly (10)) is the same light beam as seen by the observer's eye or sensor (30). A transparent display device (16) interposed between beamsplitter (1) and proximal aperture (8) receives processed data from various sensory inputs (such as a digital compass (19) and GPS receiver (18)) from the main electronics board (24), allowing an observer to view augmentation data as in FIG. 6. Further, if the user enters known coordinates to a GPS rally point (RP) (221 FIG. 6) into the device, the transparent display (16) could display a marker with the distance (223 FIG. 6) to the RP on the visible compass (220 FIG. 6) as augmented reality; additionally, a speaker (191) could produce a repeating audible beep or tone that increases in tempo and/or volume as the user turns the device towards the indicated RP. The various sensor data could be combined with the infrared (or other) low-light/no-light target images received by image sensor module (5) and displayed on wireless video display device (40), recorded on storage device (17), or viewed by multiple wireless video display devices concurrently.

In a secondary operation mode the system allows the user to retrieve locally stored audio/video files, video files, and images residing on a storage device (17) at a later time. Advantageously due to the nature of an optional polarizing beamsplitter (1) no light generated by the imaging optical assembly (10) or by the transparent display device (16) will exit distal aperture (9) maintaining covertness of the observer and is only observable through the proximal aperture (8).

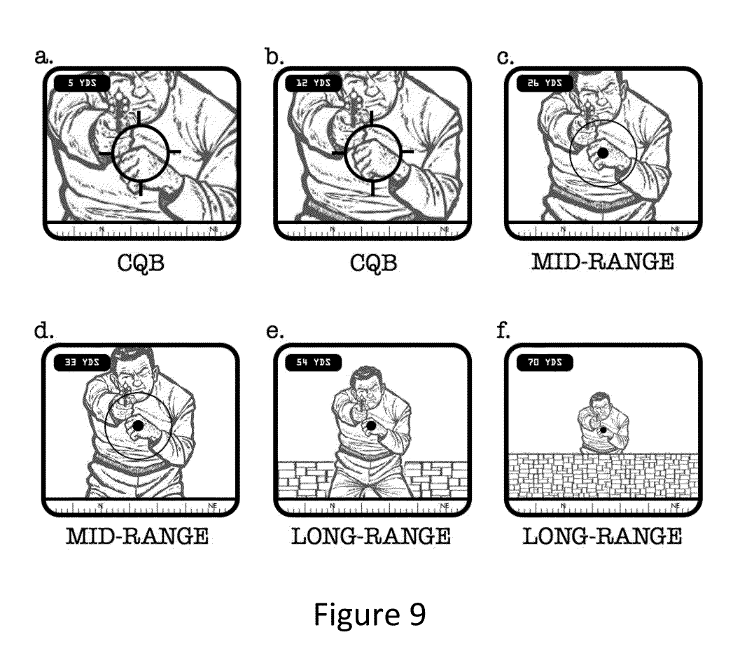

While, in general, reticles for reflex sighting systems are simple dots as in FIGS. 3a and 3b, it is possible with the system of the invention to make the reticle in any desired shape, such as the examples shown in FIGS. 3c through 3f, by the use of an engineered diffuser lens assembly (7) interposed between the imaging optics (3) and the beamsplitter (1). However, as shown in FIG. 5 in another embodiment there is provided an iris diaphragm (22) interposed between light source (2) and imaging optic (3) to automatically enlarge/reduce the targeting reticle diameter based on feedback from an integrated range finder (21) thereby preventing the reflex targeting reticle from obscuring long-range targets as illustrated in FIGS. 9e and 9f. This auto-compensating targeting reticle would necessarily take the shape of those in FIGS. 3a and 3b.

In yet another embodiment there is provided a ballistic drop compensator and electronic windage and elevation adjustment via a beam steering device. These beam steering devices can reposition the reticle's vertical/horizontal position on the beamsplitter cube (1) either manually from user input, or automatically, calculated using and algorithm based on a ballistic table of specified ammunition of the users weapon and data from an on-board range-finder (21). Additionally, the transparent display (16) could show the numerical range to target in yards/feet/meters or any suitable measurement system desired (222 FIG. 6).

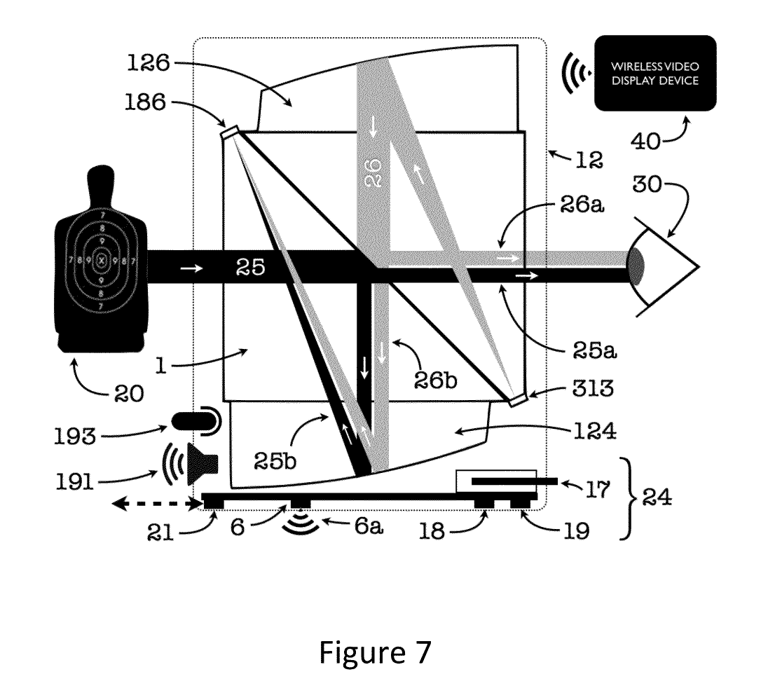

A set of specific preferred embodiments is shown in FIGS. 7 and 8. These embodiments can comprise (but are not limited to) any or all of the features contained in the previous embodiments, the only exceptions being the method in which it is boresighted and how the augmented reality information, or more accurately, the “situation-relevant information” is displayed/overlaid on the target image. The optics are illustrated in FIG. 7, and the electronic control scheme is shown in functional block diagram, FIG. 8.

In broad scope, these embodiments comprise a double off-axis parabolic mirror system that replaces an image sensor module (5 in FIGS. 1, 2, & 5) with an imaging sensor or plurality of sensors (186) and a light source (2 in FIGS. 1, 2, & 5) with a micro-display (313 in FIGS. 7 & 8). A first OAP (124) acts as an imaging lens designed for the image sensor (186), and a second OAP (126) is an imaging lens for a micro-display (313).

As in the previous embodiments, and also based upon the “advanced” electronics system, incoming light (25) from target (20) impinges upon the beamsplitter (1), some of which (25a) goes through the beamsplitter to the eye or sensor (30), and the remainder of which (25b) is reflected by the first OAP (124), which focuses the image to the proper point on the image sensor (186). The micro-display (313) projects the situation-relevant information (26) onto the second OAP (126), which collimates and reflects onto the beamsplitter (1). The situation-relevant information is split into beams (26a) and directed to the eye or sensor (30) and (26b) to the image sensor (186) via first OAP (124); additionally, both beams are substantially identical as seen by both sensors as in the prior embodiments. Although it is possible in this embodiment to use a standard, masked, or auto-iris diaphragm light source with mechanical means to boresight the device to an apparatus, it is not the preferred method. Boresighting means in this embodiment is accomplished by selective illumination of pixels on the micro-display (313) to produce a reticle image (FIG. 3) and illuminating/darkening adjacent pixels to the left, right, above, or below to affect a translation of the reticle position on the micro-display; in this manner windage and elevation adjustments are accomplished as well as some of the embodiments described in the following sections.

The construction of a double OAP beamsplitter, although novel in its concept and configuration is not complicated to construct by those skilled in the art, therefore the juxtaposition of the various parts is a novelty of this embodiment. Another important aspect of this embodiment is that the situation-relevant information displayed by (313) can either be sent to the imaging sensor (186) through double reflection (124+126) or may be digitally overlaid onto the video feed; note that in this embodiment, if doubly reflected, the eye or sensor (30) will sense the situation-relevant information and it could be used for targeting which was not possible in prior embodiments. Further, a filter (such as 4 in FIGS. 1, 2, & 5) placed in front of the image sensor (186) could be tailored to the type of image sensor used, as mentioned in prior embodiments.

### Reticle Compensation and Automated Target Acquisition Support Functions.

For some applications of the system of this invention based on the “advanced” electronics system, the sighting function may optionally incorporate automatic compensation capabilities. In firearm sighting applications of the system, for example, it may employ manual and/or automatic reticle correction to accommodate ambient factors detected by the user or sensed by the system, such as range to target, wind effects, temperature, barometric pressure, position-relative inclination and elevation, or other ambient factors that affect firing accuracy.

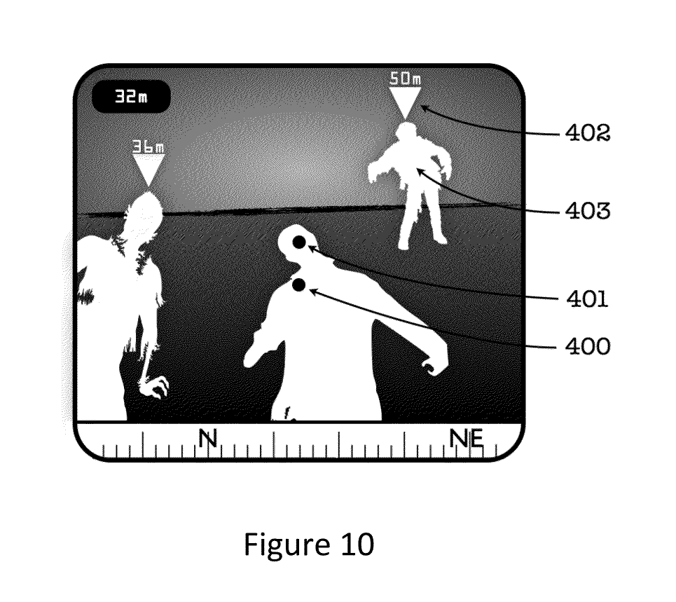

There may be built directly into the system a ranging system (21 in FIGS. 5 and 7). When the user triggers a ranging event, the ranging system reports back to the processor(s) (302) the distance to the target. The processor then can alter the location, size, and/or shape of the reticle based on the user's presets of the preferred reticle for close quarters combat, mid-range distances, or long ranges (see FIGS. 9a through 9f) or display a second, corrected, alternate reticle to show the aim point corrected for bullet drop such as in (401 in FIG. 10) and discussed in prior embodiments. BZO (battlesight zero) reticle (400, FIGS. 10 & 11) shows weapon's original aiming point when zeroed at a specified distance.

The sighting function may also employ optional synthetic aperture radar (SAR) capabilities, as illustrated in FIG. 10, which can simultaneously resolve multiple target vectors at disparate ranges to target; or it may employ more specialized sensing technology, capable of discerning potential targets that are living or the location of thermal anomalies that are visually obscured, such as well camouflaged vehicles or weapons. When activated, these automate the display of potential targets, provide for user selection of targets, and could display separate reticles for additional targets and their associated firing vectors, and/or with reticle compensation for ambient factors. This SAR system, once activated, provides a way for the user to select their targets (or with additional processing and hardware, process live or thermally significant (403 in FIG. 10) targets automatically), at which point the SAR system electronics will provide each significant target with a distance-to-target range (402 in FIG. 10). At this point, the central processing system will take each identified target, Its associated range, and automatically correct the digital reticle placement for each target based on the range data. In addition, the system measures the ranging for all points within a short radius of the selected point, which assures tracking if the target moves. The system can also correct for other environmental factors, either from manual inputs or ancillary external sensors. Further, the SAR may improve target radius resolution through communication with other augmented sighting and sensing systems and communication with other types of systems that possess target relevant data or intelligence, such as ranging data from multi-point laser ranging, LIDAR or ultrasonic detection systems.

### Augmented Image Management.

A primary feature of the system of the invention is the ability to record video and images from the sight system, inline with the sight path. This capability provides a foundation for a range of functions that augment the utility of information collected that may be based upon the advanced electronics system.

Parallel Multi-Path Operation. The system can automatically transmit the live video feed via the communications subsystem (308, FIG. 8). The system electronics and system software architecture of the system allow for an image sensor's data to be displayed to (313) and stored to (307) concurrently. The data pathways are stackable, such that the recorded raw data can be post-processed by one or a plurality of image processing methods implemented in the electronics system or in the software system, or in both. This capability applies to video, audio/video, and still image capture.

Augmentation. Because the system processor(s) (302) act in a supervisory control capacity, directing data acquisition from multiple advanced electronics system sensors (186, 316, 325, 326, 327, 328), optionally supplemented by sensing inputs (321, 322, 323), the system may apply one or several signal processing algorithms to each of the signal streams. The simplest, but still valuable, example is high fidelity image compression and/or encryption, which can reduce the elapsed time required to transmit image data. This is particularly valuable when the use of a live stream might compromise a covert user's location.

In a similar but advanced implementation, reticle derived information is used to enhance the operation of the image processing algorithms to optimize the balance of clarity and size while minimizing signal loss. This is achieved through real-time calculation of the velocities of image movement relative to the reticle that are used to optimize the bounds of an area within the image to use as a criterion zone for signal analysis and processing. When this technique is applied to a previously stored signal stream, the method permits “backward enhancement”, wherein the optimal criterion zone bounds established later in the signal stream can be applied to the optimization of frames earlier in the stream.

Advanced Augmentation. Building upon basic augmentation methods, more advanced implementations can significantly increase image utility without detracting from the live use of the system. In one such embodiment, a parallel stream of clock synchronous subchannel data, including high precision geospatial location and orientation information (325, 326, 327, 328), may be indexed by independent stream processes or processors, can be tagged to the sensor streams (321, 322, 323) that may be running at differing sample rates, such that real-time display is not slowed while providing high-clock-precision, parallel post-processing systems, and high-precision signal coherency across signal streams.

In an advanced implementation, the criterion zone bounds are applied to thermal and other non-visual data streams to establish a priority space for signal enhancement within each stream. The demarcation of features within the frame of each stream may then be used to more precisely optimize each of the other streams.

In one such implementation, automatic and/or manually triggered still-image capture while in video mode can be used to obtain high sensitivity reference points that are used to inform video signal processing algorithms. This results in a substantial improvement in the video signal-to-noise ratio. In another advanced implementation, rapid still image captures are composited using digital signal processing techniques in combination with reticle derived information to generate a composite image with greater detail than was visible with any of the individual images.

### Synthetic Blend IR Hinting

A highly useful function of the sighting system is the recording of the video image within the optic path of the sight systems, but isn't limited to recording or projecting onto the sight system's visible spectrum alone. The system can be provided with the capability to overlay additional information onto the video image and to the eye or sensor (see 30 FIG. 7).

An infrared sensor array has the capability to view light in the IR band, which correlates to thermal output of the imaged area. Adding thermal information to the sight system allows the intelligent systems to determine true live targets from non-targets and adds resolution to the available information presented to the user (see FIG. 10).

The thermal data can be lightly overlaid upon the image the user sees, which adds real-time situational awareness increasing efficiency and accuracy and reduces inadvertent targeting.

### Event Detection and Augmented Location Sensing and Response Support

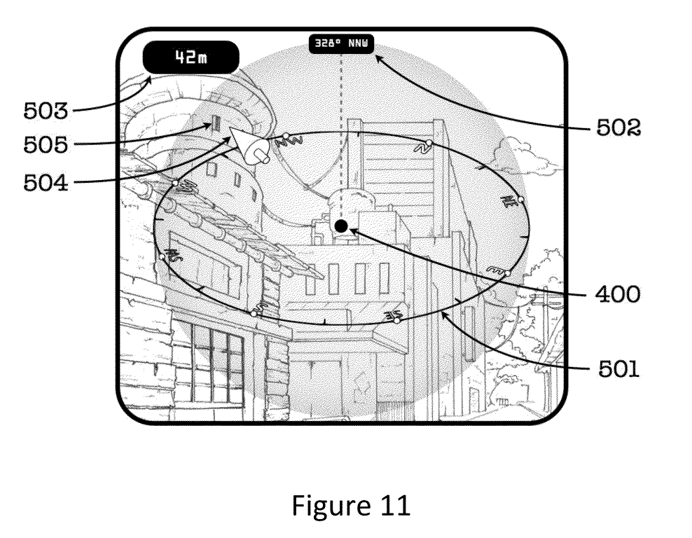

The augmented sight and sensing system's modular and extensible architecture provides for a plurality of sensed information to be managed in optical forms, digital forms, both forms separately or both as composite forms, a flexibility that enables a plurality of uses and application-specific designs. The modular and extensible architecture enables embodiment designs that include: 1) the sensed detection of a significant acoustic event; 2) the determination of the source location of the event; and 3) augmented information and decision support for the user or subsequent sensing device to react to the event, including recording of the event, its location, or a combination thereof. An illustrative embodiment for armed conflict use cases, such as military or law enforcement use, (see FIG. 11) includes sensed information such as current compass heading and “sighting wire” (502) in relation to a three dimensional compass rose (501), range to target at current compass heading and aim-point (503), a pictographic display of processed acoustic event (504), and the integrated communication thereof, providing augmented information for accurately determining the location of an acoustically significant event. For example, the user in this embodiment, knowing his actual compass bearing, may “turn-to” the source of a shot (505) align the reticle (400) and “sighting wire” (502) concurrently with the shot detection arrow (504) to engage the target, relay targeting information to his team through a plurality of means for the purpose of armed response, collect additional data, or take other appropriate actions/decisions in response.

The Shot Detection and Targeting capability (SDT) of the augmented sensing and sighting system's sensor and processing functions (FIG. 8: 321, 323, 320) determine sighting information, system relative-direction, and approximate distance to the source of detected firearm discharge or acoustically significant event. The SDT function would be PCA resident, processing of the sensed event as shown functionally (321, 323, 318) as the processor(s) and sensor functions that derive the estimated direction and distance of the source location of the acoustic event, which can be communicated in a variety of ways, for example, a multi-dimensional origin vector as shown in (FIG. 11: 504).

When the sensing and processing functions (328, 327, 321, 322, 323) calculate an origin vector (in this embodiment the source location of a shot) they incorporate the current origin vector and system relative compensated vector information (326, 325) into the data stream for display (313). The system relative compensated vector information (325, 326) is continuously sensed and recalculated as described above (328, 327, 321, 322, 323) to adjust for subsequent sensed information (325, 326) such that the current pointing vector, current response origin vector, and a current vector alignment indication are provided on display (313).

The augmented sighting and sensing system architecture as applied to armed conflicts in this embodiment allow more rapid acquisition of the response origin vector, continued alignment to the response origin vector, faster and more accurate response decisions, improved situational awareness and effectiveness of response that individually and collectively improve the safety of the user.

In this specification, the invention has been described with reference to specific embodiments. It will, however, be evident that various modifications and changes can be made thereto without departing from the broader spirit and scope of the invention as set forth in the appended claims. The specification is, accordingly, to be regarded in an illustrative rather than a restrictive sense. Therefore, the scope of the invention should be limited only by the appended claims.

1. A sighting and sensing system comprising the components;
a.) a beamsplitter that separates a target image into at least two images, one for each of at least two image sensors;
b.) means for producing situation-relevant information;
c.) at least two image sensors;
d.) at least one imaging optic to focus at least one separated images at infinity for said sensors,
e.) means to superimpose the Claims situation-relevant image upon the target image;
arranged in relationship to each other to enable each image sensor to simultaneously sense a target image or to sense a target image having superimposed upon it situation-relevant data images to form a composite image.

2. The system of claim 1 wherein the situation-relevant information are selected from the group consisting of reticles, device state information pictograms, sensed information outside the visible spectrum, situational awareness pictograms, and include audible signals.

3. The system of claim 1 also comprising an electronics module comprising electronic means that receive data from one or a plurality of sensors, processes this data to generate information to augment a composite image by superimposing the information on a target image and transmit the composite through a wired or wireless subsystem, or store on-board, or both.

4. The system of claim 3 wherein the electronic module has a power source that is equipped to be charged remotely by means of wireless methods.

5. The system of claim 4 wherein the power source selected from the group consisting of inductive charging, short wave resonance charging, long wave resonance charging, photovoltaic charging, internal dynamos and piezoelectric cell.

6. The system of claim 1 comprising means to mount the system on a standardized mounting rail with its sighting axis aligned substantially with the shooting or mounting axis of a firearm or device such that the system may be used to aim the firearm or device at a target in a traditional manner or from the safety of cover, and a means to align the sighting axis independently from its mounting axis.

7. The system of claim 1 wherein the components are incorporated in a self-contained sealed enclosure that is resistant to environmental damage.

8. The system of claim 1 wherein one of the image sensors is selected from the group consisting of a user's eye, digital camera, cellulose film camera, forward looking infra-red camera, pinhole camera, ultraviolet camera, still camera, instant camera, Schmidt camera, Wright Camera, plenoptic camera, magnetic tape video camera, camcorder, professional video camera, closed-circuit television camera, camera phone, and any combination of any of these.

9. The system of claim 1 also comprising an engineered diffuser lens assembly positioned in front of an imaging optic and light source means to provide a shaped reticle image for producing situation-relevant information.

10. The system of claim 3 also comprising a transparent display device interposed between the beamsplitter and one image sensor that receives processed signals from the electronics module allowing an observer or image sensor to view situation-relevant information.

11. The system of claim 1 also comprising electronic windage means, elevation adjustment means, a ballistic drop compensator, or electronic boresighting means.

12. The system of claim 1 also comprising one or more non-imaging-style sensors, sensor systems, remote data acquisition or remote data distribution systems, and
wherein information is acquired through one or more non-imaging-style sensors, sensor systems, remote data acquisition or remote data distribution systems, and processed and displayed through one or more display methods.

13. The system of claim 12 wherein one or more non-imaging sensors are selected from the list consisting of a synthetic aperture radar system, a shot-detection-and-location system, a SONAR or laser-based real-time physical environment mapping system, geospatial and orientation systems, audio receivers, accelerometers, digital gyroscopes, image sensors, range finders, digital compass, thermopile sensors, digital barometers, digital thermometers, and RF signal receivers, and
one or more remote data acquisition or remote data distribution systems are selected from the list consisting of a network in any topology of claimed systems sharing processed or unprocessed information, environment monitoring sensors on remotely located devices, localized warfighter information broadcast systems, centralized command center networked downlink to claimed systems, or processed information downlink from remotely operated vehicles, and
wherein acquired information is then processed on board by means selected from the list consisting of central processors, digital signal processors, digital sensor controllers, transceiver controllers, power management circuitry and controllers and digital memory, and where processed information is displayed through one or more means selected from the list consisting of display to an imaging sensor, display through a light source selected from the list consisting of lasers, light emitting diodes, incandescent lights, florescent lights, radioactive illumination, liquid crystal displays, organic light emitting diodes, infrared emitters, ultraviolet emitters, and a myriad of other visible and non-visible light producing devices, broadcast of augmented display images, and
broadcast of claimed system processed data representative of information presented through the above methods through contextual information, representative codes, or programmable ranging sensor and controlled by processing means that automatically re-sizes a reticle dot to pr coding.

14. The system of claim 1 wherein information is acquired through non-imaging-style sensors selected from the list consisting of a synthetic-aperture radar system, a shot-detection-and-location system, a SONAR or laser based real-time physical environment mapping system, geospatial and orientation detection systems; or,
remote data acquisition systems selected from the list consisting of a networked mesh of claimed systems sharing processed information, enemy monitoring sensors on remote operated aerial surveillance craft, and localized warfighter information broadcast systems processed;
the resulting situation-relevant information is presented through one or a plurality of presentation methods, selected from a list consisting of display to an imaging sensor, remote broadcast of augmented display images; and
broadcast of system-processed data stream representative of information presented through the above methods through contextual information or programmable coding.

15. The system of claim 3 comprising processed ranging data acquired from an on-board event obscuration of a target at increased distances by means of an iris diaphragm interposed between a light source and an imaging optic.

16. A method of activating a device comprising:
providing a target image having superimposed thereon situation-relevant data image(s) that is transmitted from an image sensor on the device wirelessly to an image receiver and display system; and
activation of a function of the device based upon the situation-relevant image.

17. The method of claim 16 wherein the device is a weapon, activation is the causing the weapon to fire; and
wherein the situation-relevant data comprises an image selected from the group consisting of reticles, device state information pictograms, sensed information outside the visible spectrum, situational awareness pictograms, and include audible signals.

18. The method of claim 17 also comprising an electronics module comprising electronic means that receive data from one or a plurality of the sensors, processes this data to provide an image to augment the target image by superimposing the processed data image on a target image and sends the processed data through the wireless subsystem to a receiver.

19. An imaging optic comprising;
a beamsplitter;
a pair of off-axis paraboloidal mirrors;
image sensor; and
a light source,
arranged so that incoming light beam from a target is separated into a first and second beams by the beamsplitter, the first passes to the eye of an observer or an image sensor and the second reflected by a first off-axis paraboloidal mirror that focuses the image to a sensor; the light source projects a beam containing situation-relevant data to a second off-axis paraboloidal mirror so that the situation-relevant data and the first light beam from a target are superimposed as seen by the observer and the image sensors.

20. The optic of claim 19 wherein the situation-relevant data is a shaped reticle.
